(19) United States
(12) Patent Application Publication
(10) Pub. No.: US 2006/0184579 A1
(43) Pub. Date: Aug. 17, 2006

(54) Framework for providing ancillary content in a television environment

(76) Inventors: Michael Mills, Redwood City, CA (US); Philip Mckay, San Francisco, CA (US); Michael Hoch, Campbell, CA (US); Kumiko Tanaka Toft, Carlsbad, CA (US); Rod Perkins, Menlo Park, CA (US)

Correspondence Address: BROWN, RAYSMAN, MILLSTEIN, FELDER & STEINER LLP, 900 THIRD AVENUE, NEW YORK, NY, 10022, US

(21) Appl. No.: 11/327,665

(22) Filed: Jan. 5, 2006

Related U.S. Application Data
(60) Provisional application No. 60/641,787, filed on Jan. 5, 2005.
(60) Provisional application No. 60/641,717, filed on Jan. 5, 2005.

(51) Int. Cl. G06F 17/00

(52) U.S. Cl. 707/104.1

(57) ABSTRACT

The present invention provides functionality for retrieving ancillary content associated with the content delivered to a given user's client device. According to one embodiment, the method of the present invention comprises retrieving the context of a given user and identifying a plurality of characteristics associated with the user's context. The one or more characteristics associated with the user's context are displayed to the user and the user may select from the displayed characteristics. One or more items of content are retrieved based upon the user's selection and presented to the user on the user's client device.

### PRIORITY CLAIM AND RELATED APPLICATIONS

This application claims priority to U.S. Provisional Application No. 60/641,787, filed on Jan. 5, 2005, entitled, “SYSTEM AND METHOD FOR EXTENDING ONLINE SERVICES TO OTHER PLATFORMS,” and assigned attorney docket number 7344/7P and U.S. Provisional Application No. 60/641,717, filed on Jan. 5, 2005, entitled “SYSTEM AND METHOD FOR ACCESSING PERSONALIZED MULTIMEDIA CONTENT”, and assigned attorney docket number 7344/8P, which are hereby incorporated herein by reference in its entirety.

This application is related to the following pending applications, each of which is hereby incorporated herein by reference in its entirety:
Application Ser. No. to be assigned, titled “FRAMEWORK FOR DELIVERING A PLURALITY OF CONTENT AND PROVIDING FOR INTERACTION WITH THE SAME IN A TELEVISION ENVIRONMENT,” filed Jan. 5, 2006, attorney docket number 7344/27; and
Application Ser. No. to be assigned, titled “INFORMATIONAL ALERT MESSAGING FOR DIGITAL HOME SERVICES,” filed Jan. 5, 2006, attorney docket number 7344/31.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The present invention generally provides methods and systems for facilitating the retrieval and delivery of ancillary content in a television environment. More specifically, the present invention provides methods and systems that facilitate the retrieval and delivery of ancillary content related to a given item of content as well allow user interaction with a plurality of content items.

Systems for distributing TV content are generally well known to those of skill in art. Over the past several decades, the number of systems designed for the distribution and consumption of TV content has proliferated, while the number of available channels of TV content has skyrocketed. For example, viewers are now able to consume TV content over cable, over the air broadcast, satellite, fiber optic, as well as other point (and multipoint) to multipoint distribution systems, each potentially offering several hundred channels of scheduled and on-demand TV content. Consumers have had difficulty in effectively utilizing the pool of available TV content due to a lack of useful tools for analyzing programming to determine the TV content that is potentially the most enjoyable to the user. Furthermore, the viewing of TV content has heretofore been an essentially solitary experience outside of viewing TV content with another individual located at the same location.

Current techniques for retrieving content require a television viewer to traverse the plurality of content that may be available to the given user. For example, if a given viewer enjoys a particular movie or television show, the viewer may often wish to locate similar content, such as content with the same actor, same genre, same director, etc. Existing techniques are fairly limited and require users to thus expend significant amounts of time and effort locating one or more items of content.

In order to overcome these shortcomings and other problems associated with existing apparatuses and techniques for retrieving TV content and interacting with messaging platforms, embodiments of the present invention provide systems and methods for retrieving ancillary TV content in addition to other improvements to the art.

### SUMMARY OF THE INVENTION

The present invention is directed towards methods and systems for facilitating the retrieval of content associated with a user's context. The present invention provides a user with the ability to retrieve content that has similar or matching characteristics to an item of content displayed on the user's client device. A user may search for items of content that have similar or matching genres, actor(s), directors, geographic locations, etc.

According to one embodiment, the method comprises retrieving the context of a user wherein the context of a user comprises the one or more items of content displayed on the user's client device. One or more characteristics associated with the user's context are identified. According to one embodiment of the invention, a characteristic comprises the genre of the content displayed on the user's client device. According to another embodiment of the invention, a characteristic comprises the one or more actors in a given item of content displayed on the user's client device. According to another embodiment of the invention, a characteristic comprises the geographic location depicted in an item of content displayed on the user's client device. According to yet another embodiment of the invention, a characteristic comprises the director of an item of content displayed on the user's client device.

The one or more characteristics associated with the user's context are displayed on the user's client device in conjunction with one or more items of content. One or more items of content are retrieved based upon the user's selection of the one or more characteristics. According to one embodiment of the invention, the one or more items of content retrieved have similar or matching characteristics with the one or more characteristics selected by the user. The one or more items of content retrieved are presented to the user on the user's client device.

### BRIEF DESCRIPTION OF THE DRAWINGS

FIG. 1 is a block diagram illustrating a system for providing access to messenger services and content in conjunction with TV content and ancillary TV content according to one embodiment of the present invention;

FIG. 2 is a flow diagram illustrating a method for providing TV content in addition to one or more items of ancillary content according to one embodiment of the present invention;

FIG. 3A is a flow diagram illustrating a method for identifying the one or more elements and characteristics of an item of TV content in order to retrieve one or more items of ancillary content according to one embodiment of the present invention;

FIG. 3B is a flow diagram illustrating a method for identifying active content associated with a user's context according to one embodiment of the present invention;

FIG. 4 is a flow diagram illustrating a method for delivering notification of an item of ancillary content to a user's one or more buddies according to one embodiment of the present invention;

FIG. 5 is a screen diagram illustrating the one or more items of content that may be delivered to a user's client device according to one embodiment of the present invention;

FIG. 6 is a screen diagram illustrating the one or more items of information that be retrieved for a given item of content according to one embodiment of the present invention;

FIG. 7 is a screen diagram illustrating the one or more elements and characteristics comprising a given item of content according to one embodiment of the present invention;

FIG. 8 is a screen diagram illustrating the selection of the one or more elements and characteristics comprising a given item of content according to one embodiment of the present invention;

FIG. 9 is a screen diagram illustrating the one or more items of ancillary content related to a given element or characteristic of an item of content according to one embodiment of the present invention;

FIG. 10 is a screen diagram illustrating the selection of one item of ancillary content associated with a given element or characteristic of a given item of content according to one embodiment of the present invention;

FIG. 11 is a screen diagram illustrating the one or more actions available to a user receiving one or more items of ancillary content according to one embodiment of the present invention;

FIG. 12 is a screen diagram illustrating selection of one action available to a user receiving one or more items of ancillary content according to one embodiment of the present invention;

FIG. 13 is a screen diagram illustrating the delivery of a notification of an item of ancillary content to a user's one or more buddies according to one embodiment of the present invention.

FIG. 14 is a screen diagram illustrating the delivery of ancillary content in conjunction with one or more items of content according to one embodiment of the present invention;

FIG. 15 is a screen diagram illustrating the selection of an option to retrieve one or more active items of content associated with a user's context according to one embodiment of the present invention;

FIG. 16 is a screen diagram illustrating the display of one or more active items of content associated with a user's context according to one embodiment of the present invention; and

FIG. 17 is a screen diagram illustrating an alternative embodiment for displaying the one or more items of content associated with a user's context according to one embodiment of the present invention.

### DETAILED DESCRIPTION OF THE INVENTION

In the following description of embodiments of the invention, reference is made to the accompanying drawings that form a part hereof and in which is shown by way of illustration a number of specific embodiments in which the invention may be practiced. It is to be understood that other embodiments may be utilized and structural changes may be made without departing from the scope of the present invention.

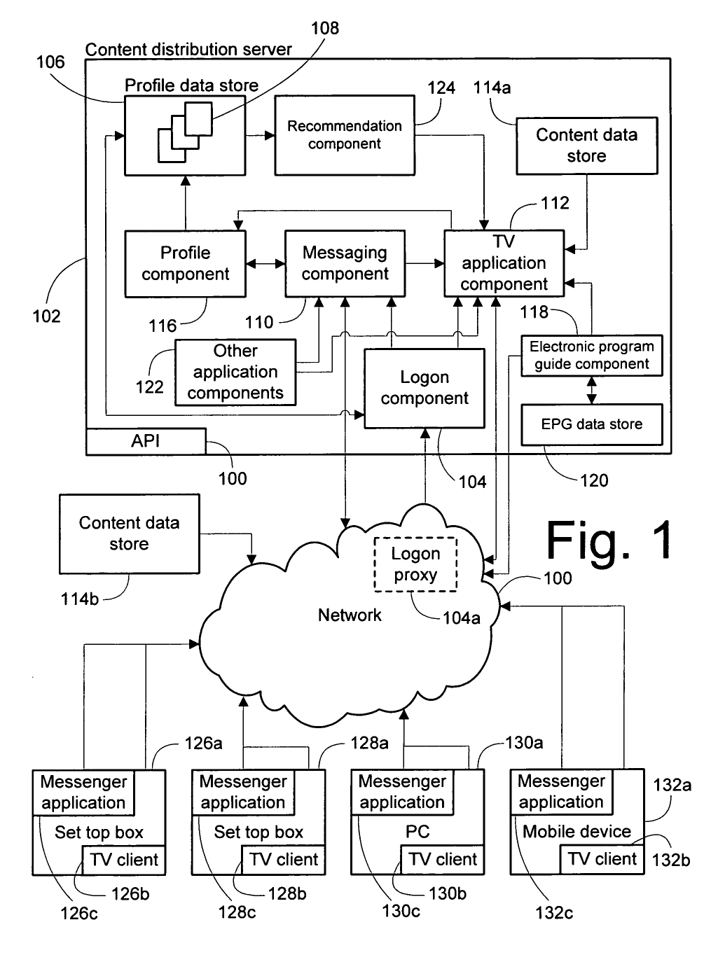

FIG. 1 presents a block diagram illustrating one embodiment of a system for providing access to messaging services and content in conjunction with television and TV related content. According to the embodiment of FIG. 1, a content distribution server 102 comprises one or more software and hardware components to facilitate the delivery of television and TV related content in conjunction with messaging and messaging related content and services. Hardware and software components include, but are not limited to, a logon component 104, a messaging component 110, a TV application component 112, a profile component 116, an electronic program guide component 118, a recommendation component 124 and other applications 122. The content distribution server 102 also comprises one or more data stores for persistent storage of information used in providing both TV and messaging content and services including, but not limited to, a profile data store 106, content data stores 114a and 114b, and an EPG data store 120.

The content distribution server 102 is communicatively coupled with a network 100, which may include a connection to one or more local and/or wide area networks, such as the Internet. Using the network 100, the content distribution server 102 is capable of accessing local 114a and remote 114b television content, as well as providing television and messaging services, including combinations thereof, to clients 126a, 128a, 130a and 132a. The content distribution server 102 is operative to provide TV and messaging content and services to any client device capable of running TV client software 126b, 128b, 130b and 132b, as well as a messaging client 126c, 128c, 130c and 132c. For example client devices may include set top terminals 126a and 128a that use a television as a display device, computer hardware such as a personal computer 130a and mobile devices 132a, such as cellular handsets and personal digital assistants (“PDA”). Other types of electronic communications equipment is contemplated as falling with in the scope of the invention including, but not limited to, digital media adapters, DVD players, connected TVs and other networked consumer electronic devices.

When a given client 126a, 128a, 130a and 132a initially accesses the content and services that the content distribution server 102 provides, the server authenticates the given user and/or client device. The content distribution server 102 provides a logon component that allows for the authentication of clients 126a, 128a, 130a and 132a and/or users of a given client device. A client deice 126a, 128a, 130a and 132a initializes its TV client application 126b, 128b, 130b and 132b and messenger client application 126c, 128c, 130c and 132c, which initiates the generation and transmission over the network 100 of a logon request to the logon component 104. According to one embodiment of the invention, the logon request comprises information identifying the user of the client device in addition to information regarding the client device itself, e.g., a MAC address, IP address, phone number or other uniquely identifying descriptor. By providing information regarding the user, the content distribution server 102 may provide a personalized experience to the user regardless of the specific client device 126a, 128a, 130a and 132a with which the user connects to the content distribution center 102.

The logon component 104 receives the logon request from a given client 126a, 128a, 130a and 132a and attempts to authenticate the user and/or device. The logon component 104 may access a profile 108 for the given user that a profile data store 106 maintains. Accordingly, the logon component 104 uses information identifying the user in an attempt to authenticate the identity of the user, e.g., against information contained in the user's profile 108. The identifying information may comprise a username and password whereby the logon component 104 conducts a comparison to ensure that the received password is identical to a stored password. Alternatively, or in conjunction, the logon component 104 may conduct an exchange of public keys with the client 126a, 128a, 130a and 132a whereby each device (client and logon component) encodes outgoing data with the received public key and decodes received data with its private key. The logon component 104 may also receive information regarding the client device 126a, 128a, 130a and 132a, e.g., a MAC address or other uniquely identifying indicia, to authenticate the client device or otherwise validate that the client 126a, 128a, 130a and 132a may connect to the content distribution server 102.

The content distribution server 102 may also implement a logon proxy 104a to provide scalability and the flexibility to handle large numbers of clients 126a, 128a, 130a and 132a attempting to connect to the logon component 104. Multiple client devices 126a, 128a, 130a and 132a initiate communication over the network 100 with a given one of one or more logon proxies 104a. Each logon proxy 104a initiates communication with the logon component 104, thereby allowing the logon component 104 to service a large number of client requests without the necessity of maintaining and managing a connection with each requesting client 126a, 128a, 130a and 132a.

Where the logon component 104 is unable to successfully authenticate the user or client 126a, 128a, 130a and 132a, the logon component 104 prevents the client 126a, 128a, 130a and 132a from accessing functionality that the content distribution server 102 offers. Alternatively, the logon component 104 may solely provide access to the TV application component 112, electronic program guide component 118 and EPG data store 120, thereby allowing the user to view TV content and scheduling data on the client 126a, 128a, 130a and 132a. A user whom the logon component is unable to authenticate is therefore presented with a traditional digital TV content viewing experience with content from one or more content sources 114a and 114b, as well as program guide data for his or her locality.

Where the logon component 104 successfully authenticates the user and/or client device, the logon component may record an indication of the successful authentication in the user's profile 108 in the profile data store 106. The logon component 104 provides an indication to the messaging server 110 and the TV application component 112 that the user and/or client 126a, 128a, 130a and 132a has been successfully authenticated and may be provided with access to the content distribution server and its constituent components identified above. Upon successful authentication, the messaging server 110 passes the identity of the user to the profile component 116, which retrieves the user's profile 108 from the profile data 106 store for transmission to the messaging component 110. The messaging component 110 may also provide the TV application 112 with a copy of the user's profile 108, or the TV application component 112 may obtain a copy of the user's profile 108 directly from the profile component 116.

The content distribution server 102 maintains a user profile 108 for each user in a profile data store 106, which is managed by a profile component 116. As indicate above, a user profile 108 maintains authentication information for the user, such as a username and password. The user profile may also be used by the messaging component 110 and TV application component 112 for the recordation of user interaction with the components, 110 and 112, respectively. Accordingly, the user profile may maintain an historical record of the interactions of the user with the content distribution server 102. Those of skill in the art should understand, however, that a subset of this historical interaction may be written to the user profile 108. For example, when the user is using the TV application component 112 to view TV content, the TV application component 112 sends a message to the profile component 116 to write indicia to the user's profile 108 in response to the receipt of a command, e.g., a change channel command. Similarly, when the messaging component 110 provides messaging content and related services to the user, the messaging component 110 sends a message to the profile component 116 instructing it to write indicia to the user's profile 108 in response to the receipt of a command, e.g., sending a message to another user or stepping into an on-line game.

The profile 108 also maintains a user's “context”. According to one embodiment, a user's context may be a notion of an action that a given user is performing at a given point in time, which may also include the location from which the user is performing that action. Put another way, a user's context may be what the user is doing at a given point in time, e.g., watching a given TV channel, playing an on-line game, listening to music, conducting an on-line transaction, etc. The context may also indicate from where or what type of device the client is connecting to the content distribution server 102, e.g., a set top box 126a and 128a, a personal computer 130a, a mobile device 132a, etc. By providing the user's context to the messaging component 110 and the TV application component 112, each component, 110 and 112, is capable of identifying and retrieving the proper content to provide the user with messaging content and related services unified with TV content and related services as is explained in greater detail herein. The profile component 116 receives updates to the given user's context form the messaging component 110 and TV application component 112 that the profile component 116 writes to the user profile 108 for the given user. The profile 108 for a given user therefore maintains an historical record of the user's context over a period of time.

The profile may also maintain information regarding other users of the system to whom a given user is related. For example, the given user may use a messaging client 126c, 128c, 130c and 132c on a client device 126a, 128a, 130a and 130a to identify one or more buddies, the identities of which are written to the given user's profile 108. By traversing groups of related users, the profile component 116 is operative to identify social networks of users. Communities of users may also exist whereby an indication of the membership in a community is written to the given user's profile 108. Similarly, the profile component 116 may identify subsets of a given user's buddies from the given user's total set of buddies. According to one embodiment, the profile component 116 calculates a social network for a given user that comprises all users with an N-degree relationship to the given user. For example, User A maintains a direct relationship with User B, and User B maintains a direct relationship to user C. User A and User C are related by two degrees, whereas each is related to User B by one degree.

The TV application component 112 identifies the user's context and retrieves the proper TV content for transmission over the network 100 to the client device 126a, 128a, 130a and 132a with which the user is interacting. Furthermore, the TV application component 112 may retrieve ancillary TV content including, but not limited to, audio, video, text, images and combinations thereof. According to one embodiment of the invention, the TV application component 112 retrieves TV content and ancillary TV content from a local content data store 114a, which may aggregate TV content and ancillary TV content from a variety of disparate sources. Alternatively, or in conjunction, the TV application component 112 receives TV content and ancillary TV content from a local content data store 114a, as well as over the network 100 from a remote content data store 114b, where required content resides remotely from the server 102. Similarly, the TV application component 112 may collect TV content from a plurality of TV content distribution systems (not pictured) for storage in the local and remote content data stores, 114a and 114b, respectively. The TV application component 112 may selectively transmit TV content to users on the basis of a schedule for the transmission of TV content promulgated by the TV content distribution system for the region in which a given user is located.

The messaging component 110 is also provided with the user's context, thereby allowing the messaging component 110 to know what actions the user is performing, e.g., watching TV content, viewing ancillary TV content, playing an on-line game, listening to music, etc. Because the messaging component 110 is aware of the user's identity, the messaging component 110 may identify other users in the given user's social network, also referred to as the user's “buddies”. With knowledge of the given user's identity and other users in the given user's social network, the messaging component 110 may instruct the TV application 112 to propagate the given user's context to other users in the given user's social network. Propagating the user's context may include generating an image representing the user's context, which may further include other data describing the user's context (e.g., text, audio, video, combinations thereof, etc.). Alternatively, information regarding the user's context may be used to lookup and retrieve additional related information from a content data store 114a and 114b. The TV application server 112 presents other users in the given user's social network with the given user's context, such as through the presentation of an icon. The TV application server 112 may provide a given user with the context of other users in the given user's social network, and vice versa.

The following example may be illustrative and is not intended to be limiting. Assume that the user is watching the TV program “The Apprentice” on channel three. According to one embodiment, the messaging component 110 identifies the user's buddies and instructs the TV application component 112 to propagate the user's context to his or her buddies. The TV application component 112 generates a thumbnail image representing the program “The Apprentice”, which the TV application component 112 propagates to the given user's buddies. The thumbnail is presented on a client device for a given buddy with information describing the program, e.g., the tile and the fact that the user is watching the program on channel three. The TV application server 112 may modify information regarding the given user's content, e.g., scaling down the thumbnail image, on the basis of a given destination client device 126a, 128a, 130a and 132a.

The messenger component 110 and TV application component 112 allow for a number of advanced features not available in content distribution systems known to those of skill in the art. Because the messaging component is aware of a given user's context and may receive input from a given client device 126a, 128a, 130a and 132a, users of the content distribution server 102 may interact with one another. The messaging component 110 provides a given user's context to the TV application component 112, which propagates the context to other users in the given user's social network and vice versa. The given user may select an indication of the context of other users in the given user's social network to initiate an action. Initiating an action may include starting an instant message conversation with the selected user, switching context to the context of the selected user, etc. Selections are passed to the messaging component 110, which performs the requested action and provides content for the TV application component to consume and propagate as is appropriate to other users. One illustrative use of this functionality is shared viewing of content between a plurality of users, shared remote control functionality between a plurality of users, combinations thereof, shared remote and shared viewing with instant messaging between a plurality of users, etc.

The messaging component 110 also provides access to other application components 122. Alternatively, other application components 122 may communicate directly with the TV application component 112 to provide content for distribution to one or more client devices 126a, 128a, 130a and 132a in communication with the content distribution server 102 over the network 100. One exemplary other application component 122 is an on-line poker playing application. The other application 122 handles the main program logic for on-line poker playing game. Each user's context (which may comprise location information (e.g., playing on-line poker), the identities of other players in the game, what the given user's action is (hit, hold, double down), etc.) is provided to the messaging component 110, which passes information regarding a given user's context to the TV application component for propagation to other players in the game.

Propagation of information regarding a given user's context may also be propagated to other users in a given user's social network who are not necessarily playing the on-line poker game. Those of skill in the art should recognize that other application components falling within the scope of the present invention are not limited to on-line poker playing components, and may include other application that may interact with the messaging component 110, including, but not limited to, music engines whereby the messaging component 110 may instruct the TV application component 112 as to the current song to which a user is listening, search applications whereby the messaging component 110 may instruct the TV application component 112 as to the keywords over which a user is searching and the related result set, etc. These are examples of a given user's context that the TV application component 112, in conjunction with the messaging component 110, may propagate to users of the content distribution server 102 to provide for a shared content consumption experience.

As indicated above, the TV application component 112 may propagate a given user's context to other users in the given user's social network, which may include channel information regarding a TV program that the given user is viewing. An issue arises, however, when individual users are accessing TV content in different time zones and locations with different channel assignments. The content distribution server 102 includes an electronic program guide component 118 communicatively coupled to the network 100 and operative to receive electronic program guide information, e.g., the program schedule for a given location and time zone. The electronic program guide component 118 queries program guide servers (not pictured) that are in communication over the network 100, such as the program guide servers operated by Tribune Media Services. The electronic program guide component 118 stores the one or more electronic program guides in an EPG data store 120. According to one embodiment of the invention, the EPG data store 120 is a relational database, but may be substituted by a tab delimited data store, a comma delimited data store, an object oriented database, a hybrid object-relational database, or other data stores known to those of skill in the art. Systems and methods for generating electronic program guides include U.S. Pat. No. 6,813,774, entitled “PROGRAM GUIDE DISPLAY APPARATUS AND PROGRAM GUIDE DISPLAY METHOD”, U.S. Pat. No. 6,763,522, entitled “SYSTEM AND METHOD FOR A DIGITAL TELEVISION ELECTRONIC PROGRAM GUIDE” and U.S. Pat. No. 6,611,958, entitled “ELECTRONIC PROGRAM GUIDE FEATURE FOR AV SYSTEM”, the disclosures of which are hereby incorporated by reference in their entirety. Furthermore, those of skill in the art recognize a number of electronic program guides are commercially available, including those available from Pioneer, Scientific Atlanta, Motorola, Gemstar/TVGuide (“GTVG”), Charter Communications, etc.

When the TV application component 112 propagates a given user's context to other users in the given user's social network, the TV application component 112 may query the electronic program guide component 118 to determine a local context for a user in the social network that corresponds to the user's context. For example, where the user is viewing a program on the ABC network, that same program is not necessarily being transmitted on the same channel in all locations and time zones, if the program is being transmitted at all. Accordingly, for each user in a given user's social network to which the TV application component 112 is to transmit a given user's context, the electronic program guide component 118 retrieves the electronic program guide from the EPG data store 120 for a user in the social network.

The electronic program guide component 118 executes a search in an attempt to locate the program that the given user is viewing in the electronic program guide. If successful, the electronic program guide component 118 instructs the TV application component 112 as to the channel on which the user in the social network may find the program that the given user is viewing being transmitted; the TV application component 112 may propagate this information as part of the given user's context. Where the electronic program guide component 118 cannot locate the given user's context in the electronic program guide, e.g., the program that the given user is viewing is not presently being transmitted in the time zone in which the user in the social network is located, the electronic program guide component 118 may identify alternate times at which the program is being transmitted, which the TV application component 112 may also propagate as part of the given user's context. The TV application component 112 transmits this information to the user in the social network. Where the client device 126a, 128a, 130a and 132a comprises digital video recording functionality (“DVR”), the TV application component 118 may provide the user in the social network with an opportunity to schedule recording of the program. Recording may also comprise the recording of content that is not selectable by a given user through interaction with an EPG, e.g., Internet based content. It should be noted that selection of a program or other content for recording may be recorded in the user's profile as a context or context change.

As an alternative to the foregoing, or in conjunction therewith, the content distribution server 102 may use a unique identifier to identify each program that it is transmitting to clients 126a, 128a, 130a and 132a, e.g., stored in the EPG data store 120. The electronic program guide component 118 searches the EPG data store 120 to locate the program that the given user is viewing and determines the program's unique identifier, which the TV application component 112 may propagate as part of the given user's context. A client device 126a, 128a, 130a and 132a that a user in the given user's social network is operating receives the given user's context and attempts to identify the program that the given user is viewing in a local electronic program guide, which may be stored on the client 126a, 128a, 130a and 132a or retrieved from a network source. If successful, client side software, e.g., a TV client 126b, 128b, 130b and 132b, instructs the user in the social network as to the channel on which he or she may find that program that the given user is viewing, which may include allowing the user in the social network to tune to channel on which the TV application component 118 is transmitting the program. Where the identifier for the program cannot be located in the local electronic program guide, client side software may identify alternate times at which the program is being transmitted. Where the client device 126a, 128a, 130a and 132a comprises digital video recording functionality (“DVR”), the client 126a, 128a, 130a and 132a may provide the user in the social network with an opportunity to schedule recording of the program. Recording functionality of the DVR may also include the recording of content that does not appear in an EPG, e.g., Internet based content.

As discussed above, interaction with the messaging component 110 and TV application component 112 may be recorded by the profile component 116, which maintains a profile 108 for each user in a profile data store 106. In other words, the profile 108 contains a history of the user's context changes as a function of time, allowing decisions to be made regarding the given user's preferences on this basis. For example, where the user's context is identified as viewing science fiction programs for long periods of time and news programs for short periods of time, a decision may be made that the user prefers science fiction programs. This may also account for sub-genres, e.g., science fiction/action, science fiction/horror, etc. Each profile 108 may also comprise context information as a function of time for other users in a given user's social network, as well as other users that utilize the content distribution server 102.

A recommendation component 124 may utilize user profiles in the profile data store to supply recommended programming to the user, which may also include providing recommendations for using other applications, such as in response to on-line events, users with whom a given user might want to be a buddy, ancillary TV content, etc. According to embodiments of the invention, the recommendation component 124 may utilize a user profile in determining recommended content to a user. Alternatively, or in conjunction with the foregoing, the recommendation component 124 may also utilize the user profiles of a given user's buddies, e.g., the profiles of those users that are in the given user's social network. The recommendation component 124 may also compute a vector for the given user's profile and include those users with similar profile vectors in its calculation of recommended content. Also, the recommendation component 124 may utilize profiles for user communities, which contain aggregate context information for a community of users, when determining recommended content. Similarly, the recommendation component 124 may utilize a personalization service, such as My Yahoo!, which allows users to create and edit their own profiles for indicating media preferences (e.g., favorite channels or TV programs), which are stored on Yahoo! servers (which may be profile data stores 106) and made available to the recommendation component 124.

The recommendation component 124 allows the content distribution server 102 to harness the viewing experience, habits and preferences of the users who are interacting with the content distribution server 102. As indicated above, the recommendation component 124 may provide recommendations beyond TV content, extending to all services that the content distribution server offers. For example, a user may interact with the messaging component 110 to access other application component 122 through the TV application component 112. One exemplary other application component 122 is an on-line poker game in which users play against each other on line. Where the user profile indicates that the user spends substantial time in the context of an on-line poker application 122, the recommendation component may alert the user when an upcoming on-line poker tournament is approaching.

The system of the present invention illustrated at FIG. 1 provides for a shared content consumption experience for users of the content distribution server 102. A given user may be informed of the context of other users of the system, including users in the given user's social network. According to one embodiment, icons and accompanying textual data are propagated by the TV application component and presented to the given user on a client device 126a, 128a, 130a and 132a, indicating the context of other users of the server 102. The presentation of the context of other users in conjunction with the presentation of TV content allows for a shared viewing experience whereby a given user may know the context of other users and may change his or her context to that of another user. For example, where the context of a user in a given user's social network indicates the user in the social network is watching a program that is enjoyable to the given user, the given user may change his or her context to match that of the user in the social network (e.g., tuning to receive transmission of the same TV content that the user in the social network is consuming). Using the architecture described herein, a number of applications become available in the context of the TV consumption process, including, but not limited to personalization, community viewing, shared presence and context, messaging, access to ratings and recommendations (including community reviews), alerts, etc.

The content service provider 102 provides access to it functions and application components through the use of one or more application program interfaces (“API”) 100. An API 100 is an interface, or set of calling conventions, by which a given application component accesses other application components and the services that the application components offer. By using the API 100, a given application component advertises information regarding the functions and/or services that the given application component may provide to other components, which may also include the technique by which the functions or services are accessed. This allows the application components comprising the system to access supporting system and network services. For example, the API 100 allows client side applications to issue function calls for the performance of actions and accessing of services, such as tuning a channel, accessing an on-line game, listening to music, allowing the messenger component to interface with the TV application component or a messaging client to access EPG data, etc., as described herein. Although FIG. 1 illustrates the API 100 as a separate system component, those of skill in the art recognize that each application component may provide an individual API 100 identifying the specific functions and services a given application component provides. Furthermore, application components, e.g., a messaging client 126c, 128c, 130c, 132c, resident on client devices 126a, 128a, 130a, 132a may provide one or more APIs 100 advertising the functions and service the given application component provides.

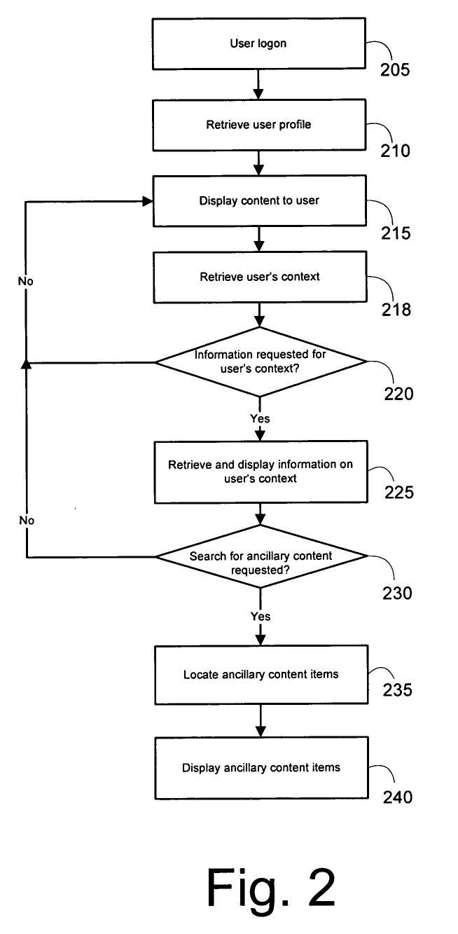

FIG. 2 is a flow diagram illustrating one embodiment of a method for providing TV content in addition to one or more items of ancillary content to a user's client device. According to the embodiment illustrated in FIG. 2, a user of a client device may initialize and connect to a logon component, step 205. Initialization may comprise a client device powering up and initializing a communications stack, such as a TPC/IP stack, and opening a connection to the logon component over a network, e.g., the Internet. The logon component attempts to verify a user's credentials using information maintained in the user's profile that may be retrieved by a profile component, step 210.

Television content may be retrieved and displayed to a user on the user's client device using a TV application component, step 215. According to one embodiment of the invention, a TV application component retrieves content from a content data store based upon a user's selection of content from among a plurality of television shows available to the user. For example, an electronic programming guide component may retrieve an electronic program guide from an EPG data store identifying one or more items of television content available to a user. The electronic programming guide may be displayed to the user who may select one or more items of television content from the electronic programming guide. According to another embodiment of the invention, the television content retrieved and displayed to a given user is based upon the user's profile maintained in a profile data store. For example, a user's profile may maintain information identifying the age, location, sex, etc., of the given user. A TV application component may retrieve and display content to a user based upon the one or more items of information maintained in the user's profile. The content retrieved by a TV application component may comprise audio, video, text, images and combinations thereof.

According to the embodiment illustrated in FIG. 2, a user may request information on the one or more items of content delivered to the user's client device. For example, a user viewing a given item of television content may desire information identifying the type of content, a summary of the content, one or more ratings for the content, etc. A messaging component may retrieve and identify the context of the given user and deliver the context of the user to a TV application component to identify information associated with the one or more items of content displayed on the user's client device, step 218. For example, if the messaging component determines that a given user is viewing the movie “Anchorman,” the messaging component may deliver such information to a TV application component. The TV application component may retrieve one or more items of information from a content data store associated with the movie “Anchorman”, such as a summary of the movie, ratings provided by one or more users of the system described herein, critics' ratings, etc.

A check is performed to determine whether a given user requests information for the one or more items of content displayed to the user on the user's client device, step 220. If a user does not request any information, the user may continue to browse the plurality of content available to the given user, step 215. For example, a user may continue to browse the plurality of content available to the user as identified in an electronic programming guide. Alternatively, if a user requests information for the one or more items of content displayed to the user, the context of the user may be utilized to retrieve one or more items of information for the one or more items of content being displayed to the given user, step 225. As previously described, a messaging component may identify a given user's context and deliver the user's context to a TV application component to retrieve one or more items of information associated with the one or more items of content displayed to the given user. The TV application component may query a content data store, or other data storage device operative to store one or more items of information associated with one or more items of content, to retrieve information associated with a given user's context. For example, the TV application component may query a database communicatively coupled to the TV application component, such as Amazon.com's Internet Movie Database, to retrieve information associated with a user's context. The information retrieved may comprise rating information, the duration of a given item of content, broadcast information, a summary, parental control information, etc.

The one or more items retrieved that are associated with a given user's context may be displayed to the user in conjunction with the one or more items of content displayed on the user's client device, step 225. For example, if rating and summary information are obtained for a user's given context, the rating and summary information may be displayed in conjunction with the content displayed on the user's client device. Thus, a user viewing the movie “Anchorman” may retrieve information on the movie, such as critics' ratings, user ratings, etc., and view such information while simultaneously viewing the movie.

According to the embodiment illustrated in FIG. 2, a user may also request one or more items of content associated with the context of the given user (hereinafter referred to as “ancillary content”). For example, a user may be viewing a comedy movie with a particular actor and wish to locate other items of content that contain the given actor. Similarly, the user may be viewing a particular genre of television content, such as a reality television show, and may wish to locate other types of reality television shows. According to one embodiment of the invention, a user is presented with an option to search for similar items of ancillary content. As illustrated in FIG. 2, a check is performed to determine whether a given user wishes to search for ancillary content associated with the content displayed to the user, step 230. If a user does not wish to search for items of ancillary content, the user may continue to view the content displayed on the user's client device or browser the plurality of content available to the given user, step 215. Alternatively, if a user wishes to search for items of ancillary content, a search is performed to locate items of ancillary content that are associated with the user's context, step 235. According to one embodiment of the invention, a messaging component retrieves the context of a given user and delivers the user's context to a TV application component. A TV application may query a remote or local content data store to locate one or more items of ancillary content associated with the content displayed to the user on the user's client device.

The one or more items of ancillary content associated with the user's context are retrieved and displayed on the user's client device, step 240. According to one embodiment of the invention, a TV application component delivers a list comprised of the one or more items of ancillary content to a user's client device in conjunction with the content being viewed by the user. A user may browse the one or more items of ancillary content and select a given item of ancillary content. For example, using a selection device, such a remote control or mouse, a user may traverse the list of ancillary content and select a given item of ancillary content.

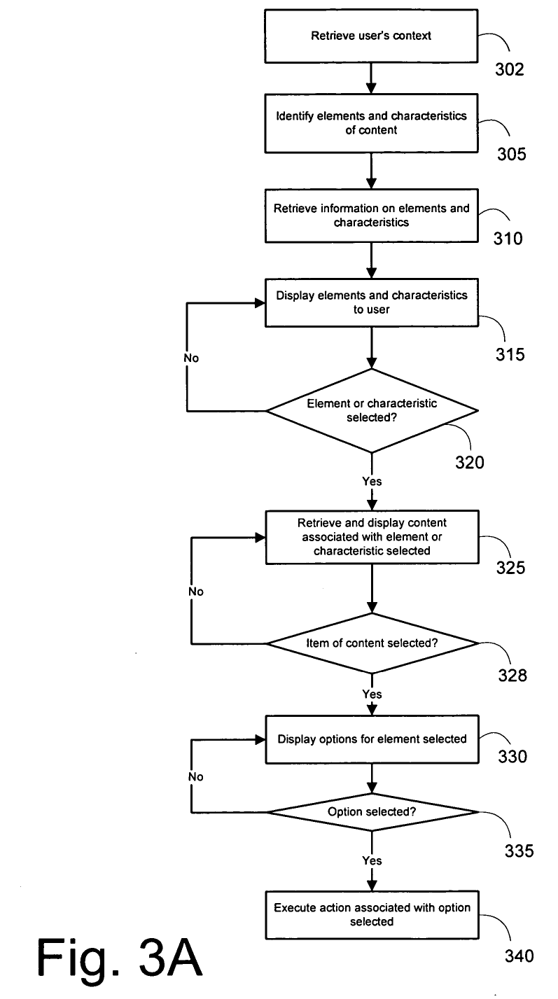

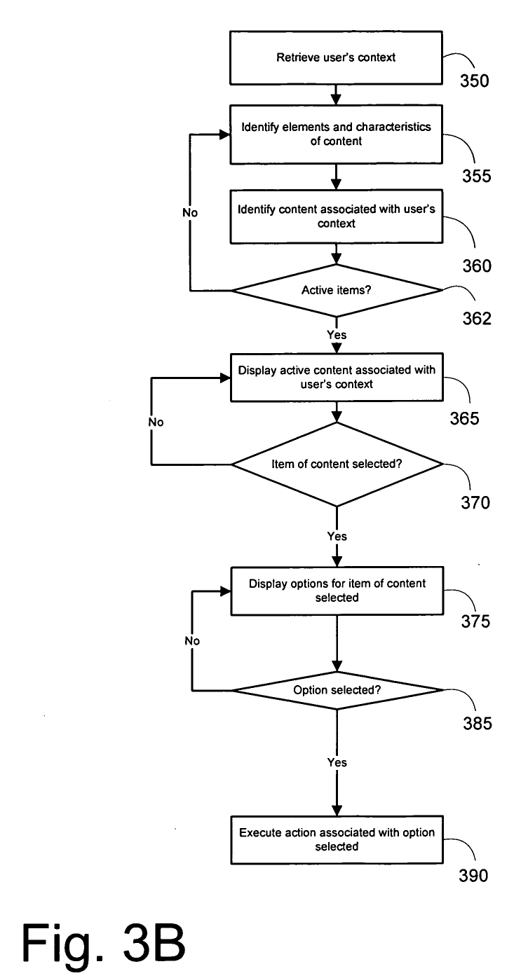

FIG. 3A illustrates one embodiment of a method for locating one or more items of ancillary content associated with a given user's context. According to the embodiment illustrated in FIG. 3A, the context of a given user is retrieved, step 302. For example, a messaging component may retrieve the context of a given user, wherein a user's context may comprise a particular television show, movie, etc. The context of a user may be delivered to a TV application component that may use the given user's context to identify one or more elements associated with the user's context, step 305. For example, a user may be viewing the movie “Anchorman.” The context of the user (viewing “Anchorman”) may be retrieved by a messaging component and delivered to a TV application component. A TV application component may use the context to identify the one or more elements or characteristics associated with the user's context. According to one embodiment of the invention, an element of a given context comprises the genre of the content displayed to a given user. According to another embodiment of the invention, an element of a given context comprises one or more actors in a given item of content. According to yet another embodiment of the invention, an element of a given context comprises the geographic location depicted in the content displayed to a user. Those of skill in the art recognize other elements that may be associated with one or more items of television content.

Information is retrieved on the one or more elements associated with a given context as identified by a TV application component, step 310. According to one embodiment of the invention, a TV application retrieves information for the one or more elements associated with a given context from a content data store or other storage device operative to store a plurality of information associated with a given context. The context of a given user may be used to determine the one or more items to retrieve from a content data store. According to one embodiment of the invention, one or more templates may be used to retrieve information on the one or more elements associated with a given context. For example, one or more templates may be associated with the one or more types of contexts, such as a “movie template” for a movie context, “television show template” for a television show context, “sports template” for a sports context, etc. Each respective template may identify one or more elements that comprise the respective context. For example, a movie template may identify that a movie is comprised of the elements “actor(s),” “director,” “duration,” “rating,” “year,” etc. Similarly, a sports template may identify that a sports game is comprised of the elements “first team,” “second team,” “location,” etc. The template associated with a given user's context may be utilized to retrieve the one or more elements identified in the respective template.

Information retrieved for the one or more elements associated with a given context are displayed on a user's client device, step 315. According to one embodiment of the invention, a user is presented with a list of the one or more elements associated with the given user's context. For example, a user viewing the movie “Anchorman” may be presented with a list displaying the one or more actors in the movie, the geographic setting of the movie, the movie genre, etc. The user may select one or more of the elements associated with the user's context using a selection device such as a remote control or a mouse. A check is performed to determine whether any of the one or more elements associated with a given user's context are selected, step 320. If none of the one or more elements are selected, the user may continue to traverse the list of one or more elements or deactivate the display of the one or more elements and continue to view the content displayed on the user's client device. If an element is selected, a search is performed to locate one or more items of ancillary content associated with the selected element, step 325. For example, if a user selects the “actor” element associated with a movie displayed on the user's client device, a search is performed to locate one or more items of ancillary content with the actor selected. Similarly, if a user selects the “genre” element associated with a movie displayed on the user's client device, a search is performed to locate one or more items of ancillary content identified as a similar genre. According to one embodiment of the invention, the user's selection is delivered to a TV application component that searches a content data store to identify one or more items of ancillary content associated with the user's selection. The one or more items of ancillary content located by a TV application component are retrieved and displayed on a user's client device, step 325. According to one embodiment of the invention, the one or more items of ancillary content are displayed in a list with an indication of where the ancillary content may be retrieved. For example, if a user viewing a given comedy movie selects the “comedy” element (i.e., genre), a list of one or more comedy items of ancillary content may be displayed on the user's client device. Additionally, an indication may be displayed in conjunction with each comedy item listed, indicating that the ancillary content is available from a pay-per-view service, from a user's local digital video recorder, etc. According to one embodiment of the invention, an image associated with the one or more locations from which ancillary content may be retrieved is displayed in conjunction with the one or more items of ancillary content.

Using a selection device, such as a remote control or a mouse, a user may select one or more of the items of ancillary content displayed. According to the embodiment illustrated in FIG. 3A, a check is performed to determine whether a given item of ancillary content is selected, step 328. If a user does not select any of the one or more items of ancillary content displayed, the user may continue to traverse the one or more items comprising the list of items or deactivate the display of the list of items, step 325. When an item of ancillary content is selected, one or more options are displayed to a user, wherein the one or more options may comprise actions that may be executed with respect to the item of ancillary content selected, step 330. For example, an action associated with an item of ancillary content may comprise recording the ancillary content on a storage device operative to record one or more items of content such as a digital video recorder (“DVR”). Similarly, an action associated with an item of ancillary content may comprise viewing a trailer associated with the given item, wherein a trailer may comprise a short film advertisement for a movie. Furthermore, an action associated with an item of ancillary content may comprise notifying the one or more users in a given user's social network of the item of ancillary content selected.

A check is performed to determine whether a user selected one or more of the options available for a given item of ancillary content, step 335. If a user does not select any of the available options, the user may continue to view the content displayed on the user's client device or browse the one or more options available for the given item of ancillary content, step 330. When an option associated with a given item of ancillary content is selected, the action associated with the option selected is executed, step 340. For example, a user may be presented with several options for a given item of ancillary content wherein one of the options may be to view a trailer. If the user selects the option to view the trailer, the selection may be delivered to a TV application component. The TV application component may retrieve the content associated with the trailer, such as a fifteen second film, and deliver the content to the user's client device. The trailer may be viewed in conjunction with one or more other items of content displayed on the user's client device. Similarly, if a user is presented with an option to record an item of ancillary content, the user may select the option to schedule the time and date for recording the given item of ancillary content while viewing one or more items of content displayed on the user's client device. Further, if a user is presented with an option to deliver a notification to one or more buddies in the user's social network, the user may select the option to notify the user's one or more buddies of the ancillary content item selected.

FIG. 3B illustrates one embodiment of a method for locating one or more items of active content associated with a given user's context, wherein active content comprises one or more items of content immediately available to a user for viewing or recording. According to the embodiment illustrated in FIG. 3B, the context of a user is retrieved, step 350. A messaging component may identify the context of a user, such as the television show the user is watching. The context of the user may be delivered to a TV application component that may utilize the user's context to identify one or more elements or characteristics associated with the user's context, step 355. According to one embodiment of the invention, the context of the user is retrieved by a messaging component and delivered to a TV application component that uses the context to identify the one or more elements or characteristics associated with the user's context. As previously described, an element of a user's context may comprise the genre of the content displayed to the user, the one or more actors in a the content displayed to the user, the geographic location depicted in the content displayed to the user, etc.

The one or more elements or characteristics associated with a user's context are used by the TV application component to find one or more items of active content associated with the user's context. According to one embodiment of the invention, the TV application component queries a content data store to find one or more items of content associated with the one or more elements or characteristics associated with a user's context. For example, the TV application component may query a content data store to locate one or more items of content with the same actor associated with a user's context, the same director associated with a user's context, etc. The TV application thereafter performs a check to determine whether any of the one or more items of content identified as associated with the user's context are active, step 362. According to one embodiment of the invention, an active item of content comprises an item of content that may be immediately viewed or recorded by a given user. If none of the one or more items of content associated with a user's context are identified as active, the TV application component may identify additional characteristics or elements associated with the user's context, step 355. When one or more items of active content associated with the user's context are identified as active, the one or more items are displayed to the user on the user's client device, step 365.

A check is performed to determine whether a user has selected one or more of the active items of content associated with the user's context, step 375. For example, the user may select an active item of content using a selection device such as a mouse or a remote control. If a user does not select any of the one or more active items of content associated with the user's context, the user may continue to browse the one or more active items of content available, step 365. Alternatively, if a user selects an active item of content, step 370, the user is presented with one or more options associated with the active item of content selected, step 375. According to one embodiment of the invention, the user is presented with one or more controls for interacting with the item of content selected. For example, a user may be presented with one or more actions that may be executed with respect to the item of content selected, such as recording the item of content on a DVR, retrieving rating information for the item of content, viewing a clip or trailer for the item of content selected, etc. Similarly, the user may be presented with an option to change the user's context to the active item of content selected.

A further check is performed to determine whether a user selected one or more of the options associated with the active item of content selected, step 385. For example, the user may select one or more of the options associated with the active item of content selected using a selection device such as a remote control or a mouse. If a user does not select any of the options associated with the active item of content selected, the user may continue to browse the one or more options available, step 375. If an action is selected, step 385, the action selected by the user is executed, step 390. For example, if a user selects an option to record an item of active content associated with the user's context, the item of content may be recorded on the user's DVR while the user continues to view one or more items of content. Similarly, if the user selects an option to change to the user's context to the active item of content selected, the user's context is changed to reflect the user's selection.

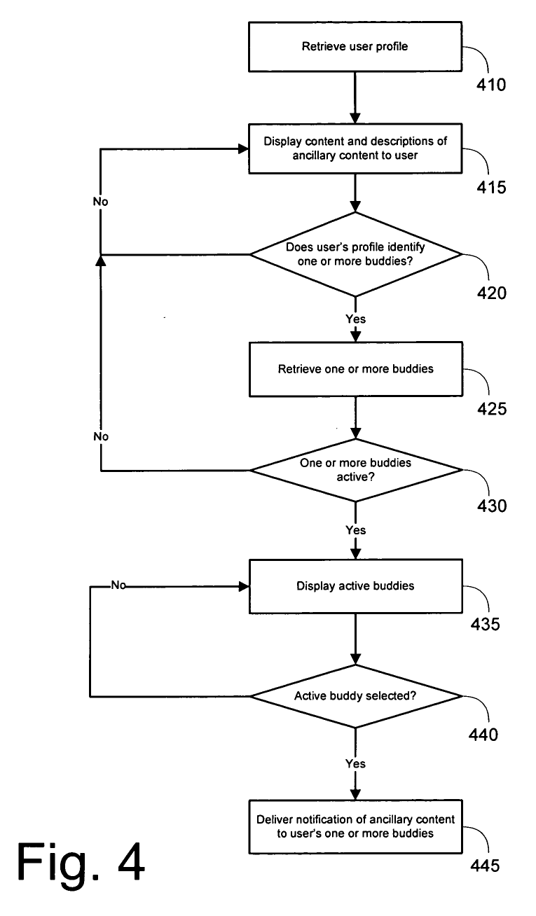

FIG. 4 illustrates one embodiment of a method for notifying a user's one or more buddies of one or more items of ancillary content, wherein ancillary content may comprise content associated with a given user's context. The profile of a user logged on to the system described herein may be retrieved by a profile component operative to retrieve one or more user profiles from a profile data store, step 410. One or more items of content may be retrieved and delivered to a user's client device, step 415, wherein the one or more items of content may comprise television content. Additionally, one or more items of ancillary content associated with the content delivered to a user may be retrieved and displayed on the user's client device, according to the methods described herein, step 415.

The user profile retrieved may be utilized to identify one or more users in a given user's social network (“buddies”). According to one embodiment of the invention, a messaging component retrieves the one or more buddies designated in a user's profile that maintain profiles on the system described herein. According to another embodiment of the invention, a messaging component identifies a user's one or more buddies based upon the one or more instant messaging applications to which a user has subscribed. For example, a user may subscribe to one or more instant messaging applications such as Yahoo! Messenger, AOL Instant Messenger, etc. A messaging component may identify the one or more instant messaging applications and retrieve the buddies designated in each respective instant messaging application.

A check is performed to determine whether a given user's profile identifies one or more buddies with profiles maintained on the system described herein or one or more buddies designated as such in one or more instant messaging applications, step 420. If the user's profile does not identify one or more buddies, the user may continue to view the content and ancillary content displayed on the user's client device, step 415. If one or more buddies are identified in the user's profile, the one or more buddies are retrieved, step 425. A further check is performed to determine whether any of the one or more buddies in a given user's social network are active, step 430. According to one embodiment of the invention, a given buddy is active if the buddy is logged on to the system described herein. According to another embodiment of the invention, a given buddy is active if the buddy is logged in to one or more instant messaging applications as identified by a messaging component. If one or more of a user's buddies are identified as active, the user is notified of such, step 435. According to one embodiment of the invention, a message is displayed to a user notifying the user of the one or more buddies that are active. If none of a user's one or more buddies are active, a user may continue to browse the plurality of content and ancillary content available to the user, step 415.

A user may wish to notify one or more of the user's active buddies of one or more items of ancillary content displayed on the user's client device according to the methods described herein. For example, a user may wish to notify one or more of the user's buddies of a television show that the user enjoys watching or that the user believes will be enjoyable to the one or more buddies. Similarly, a user may wish to notify one or more of the user's buddies of an actor that the user particular enjoys. A user may thus select one or more of the buddies identified as active and displayed on the user's client device in order to deliver a notification of the ancillary content displayed on the user's client device, step 440. If a user does not select any of the one or more active buddies, the user may continue to view the content and ancillary content displayed on the user's client device, as well as browse the one or more buddies identified as active, step 435. In contrast, if a user selects an active buddy, a messaging component delivers a notification to the given buddy, providing the buddy with a notification of the ancillary content selected and displayed on the user's client device, step 445. According to one embodiment of the invention, the notification delivered to a user's one or more buddies comprises an email notification delivered to each buddies' respective email address. According to another embodiment of the invention, the notification delivered to a user's one or more buddies comprises a pop-up displayed on each buddies' respective client device. Those of skill in the art recognize other methods for delivering a notification to a user's one or more buddies for a given item of ancillary content.

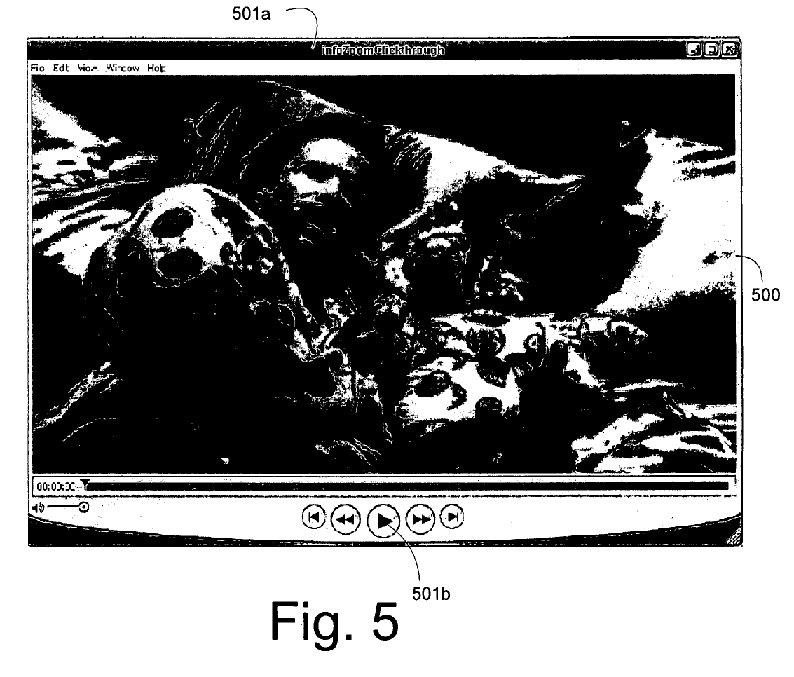

FIG. 5 is a screen diagram illustrating the content that may be displayed on a user's client device. It should be noted that while FIG. 5 through FIG. 17 provide screen diagrams illustrating the plurality of content that may be available to a user's client device, the border and controls 501a and 501b appearing in FIG. 5 through FIG. 17 would not appear on a user's client device. A user of the system described herein may logon using a logon component that may verify the user's credentials as stored in the user's profile. Once logged in, a user may select from among a plurality of content available to the user that may be delivered to the user's client device. As illustrated in FIG. 5, the content 500 delivered to a client device may comprise television content that is available to a given user. For example, the content 500 available to a given user may be based upon the geographic location of the user. According to one embodiment of the invention, an electronic program guide component may query an electronic program guide data store to identify one or more electronic program guides available to a given user. The one or more electronic program guides identified by the electronic program guide component may be displayed to the user on the user's client device. The user may select an item in the electronic program guide, which may result in a TV application component retrieving and delivering content 500 to the user's client device.

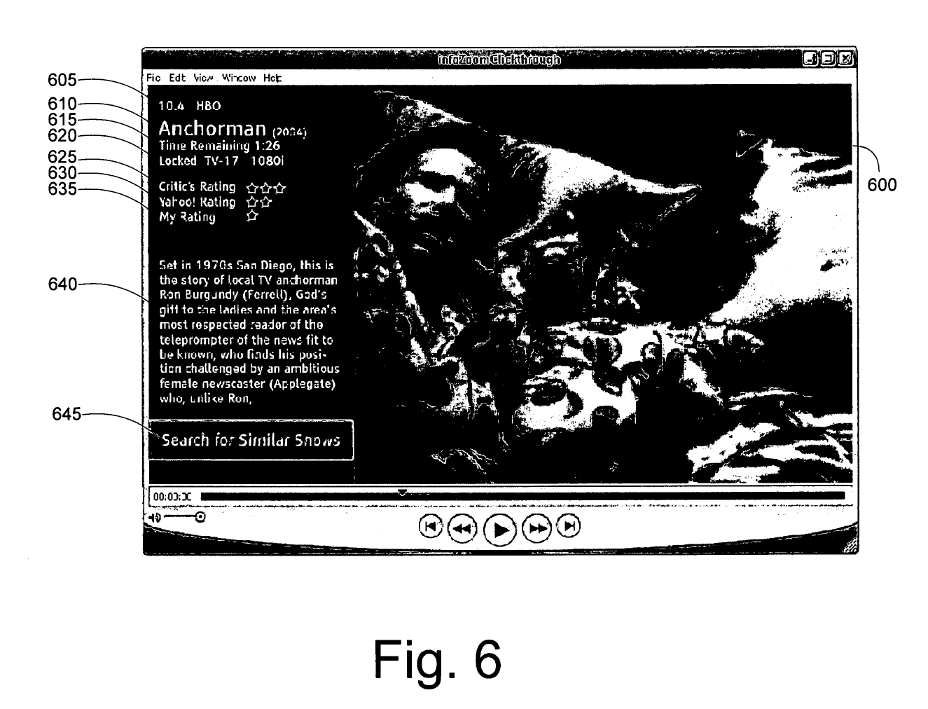

FIG. 6 is a screen diagram illustrating the plurality of information that may be retrieved for a given user's context. As illustrated in FIG. 6, a user may continue to view the content 600 delivered to the user's client device, as described in FIG. 5, while browsing the plurality of information 605, 610, 615, 620, 625, 630, 635 and 640 associated with the content 600 delivered to the user's client device. According to one embodiment of the invention, a messaging component may retrieve a user's context and deliver the user's context to a TV application component. The TV application component may retrieve one or more items of information associated with the user's context from a content data store and deliver the one or more items of information to the user's client device. As illustrated in FIG. 6, the one or more items of information may comprise channel or broadcasting information 605, title information 610, duration information 615, parental control information 620, as well as a summary of the content associated with a given user's context 640.

Additionally, rating information 625, 630 and 635 may be retrieved and displayed in conjunction with the content 600 displayed to the user. The rating information 625, 630 and 635 may be based upon ratings from one or more critics 625, one or more providers of content 630 or a given user's profile. According to one embodiment of the invention, a messaging component may retrieve the context of a given user and deliver the context of the user to a TV application component. The TV application may retrieve one or more ratings 625, 630 and 635 associated with a given user's context from a content data store and deliver the one or more ratings to the user's client device. According to another embodiment of the invention, a user logged on to the system described herein may enter ratings for one or more items of content. A user's profile may be annotated with the one or more ratings entered by the user for the one or more items of content. As illustrated in FIG. 6, a user requesting information for a particular item of content may receive the user's previous ratings 635 for the given item of content.

A user may also be presented with an option to search 645 for ancillary content (“similar shows”) associated with the given user's context. Using a selection device such as a mouse or a remote control, a user may select the “Search for Similar Shows” 645 button to locate ancillary content associated with the content 600 displayed on the user's client device.

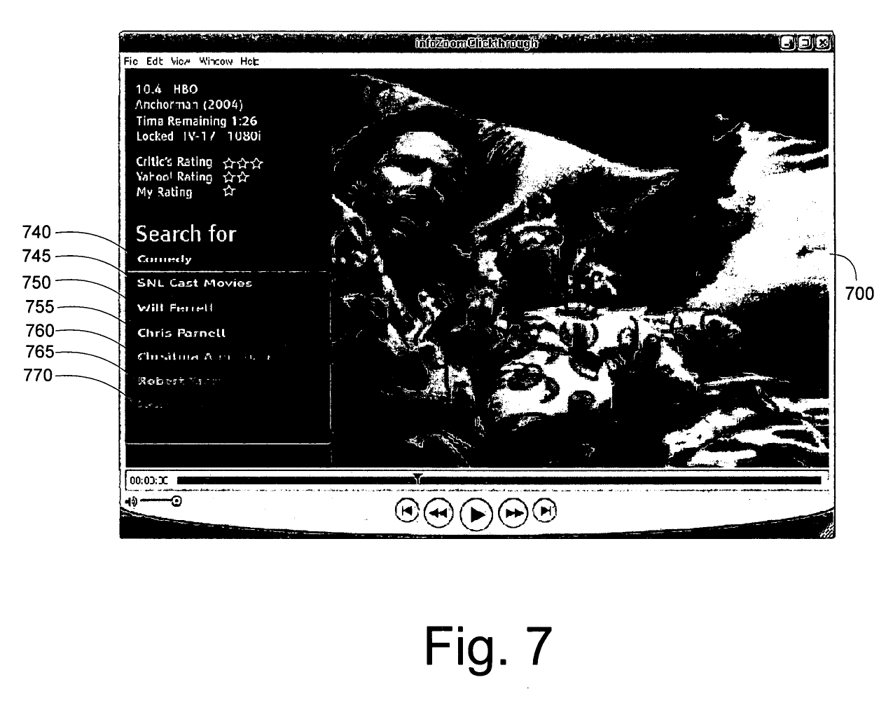

FIG. 7 is a screen diagram illustrating the one or more elements or characteristics 740, 745, 750, 755, 760, 765 and 770 associated with a given user's context that may be displayed to a user upon selection of the “Search for Similar Shows” button illustrated in FIG. 6. According to the methods described herein, the context of user may be utilized to identify one or more elements or characteristics 740, 745, 750, 755, 760, 765 and 770 associated with the user's context. As illustrated in FIG. 7, a movie 700 may be displayed on a given user's client device. The user's context (i.e., viewing the movie “Anchorman”) may be utilized to identify one or more associated elements or characteristics 740, 745, 750, 755, 760, 765 and 770. For example, a movie context may be comprised of the elements “actor(s),” “geographic location,” “genre,” etc. Similarly, a sports context may be comprised of the elements “first team,” “second team,” “location,” “league,” etc. The one or more elements 740, 745, 750, 755, 760, 765 and 770 identified for a user's particular context may be used to retrieve information for each respective element. According to one embodiment of the invention, a user's context is retrieved by a messaging component and delivered to a TV application component. The TV application component may identify the one or more elements 740, 745, 750, 755, 760, 765 and 770 associated with a given user's context and retrieve information for the one or more elements from a content data store. The information retrieved may be delivered to a user's client device. As illustrated in FIG. 7, the information retrieved for the one or more elements 740, 745, 750, 755, 760, 765 and 770 associated with a user's context may be displayed in a list, allowing a user to traverse and select the one or more elements 740, 745, 750, 755, 760, 765 and 770 with a selection device such as a remote control or a mouse while viewing the content 700 displayed on the user's client device.

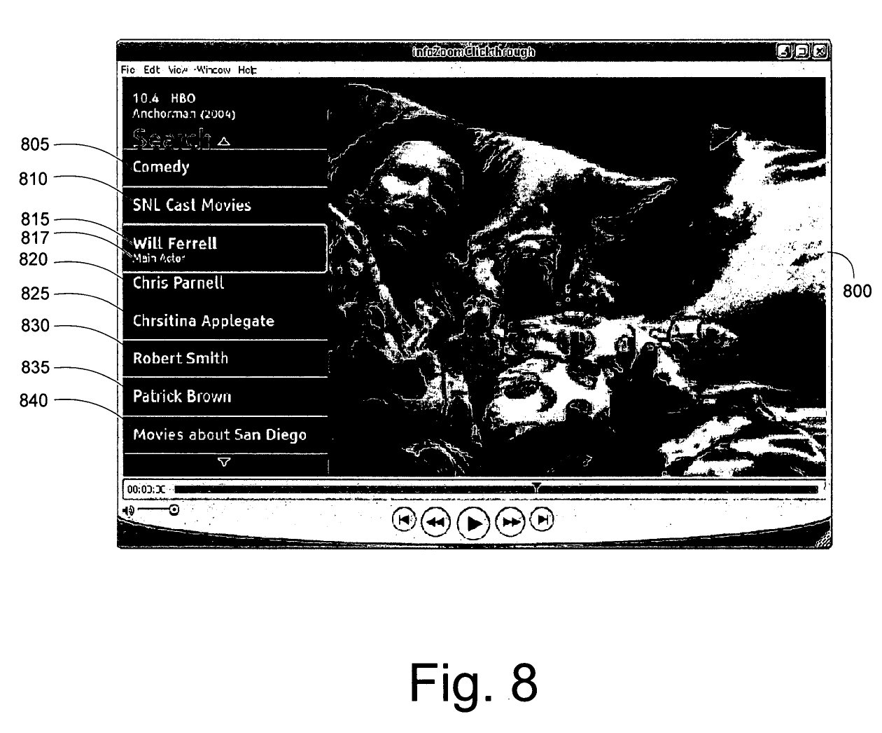

FIG. 8 is a screen diagram illustrating the additional information displayed to a user as the user traverses the list of elements 805, 810, 815, 820, 825, 830, 835 and 840 associated with the user's context. The one or more elements 805, 810, 815, 820, 825, 830, 835 and 840 associated with the content 800 displayed to the user may be traversed using a selection device such as a mouse or a remote control. As a user highlights or otherwise marks a given element 805, 810, 815, 820, 825, 830, 835 and 840 in the list of one or more elements, additional information 817 is displayed to the user, further identifying the element. As illustrated in the screen diagram of FIG. 8, when a user highlights or otherwise marks the element “Will Ferrell,” 815 the user is presented with information 817 identifying Will Ferrell as the main actor of the content 800 displayed on the user's client device.

The one or more elements 805, 810, 815, 820, 825, 830, 835 and 840 associated with the content 800 displayed on the user's client device may also be selected, thereby resulting in a search for ancillary content associated with the given element 805, 810, 815, 820, 825, 830, 835 and 840 selected. Using a selection device such as a mouse or a remote control, a user may select an element 805, 810, 815, 820, 825, 830, 835 and 840 in the list of one or more elements to search for ancillary content associated with the element selected. According to one embodiment of the invention, a user's selection of a given element 805, 810, 815, 820, 825, 830, 835 and 840 is delivered to a TV application component, operative to retrieve one or more items of ancillary content associated with the element selected.

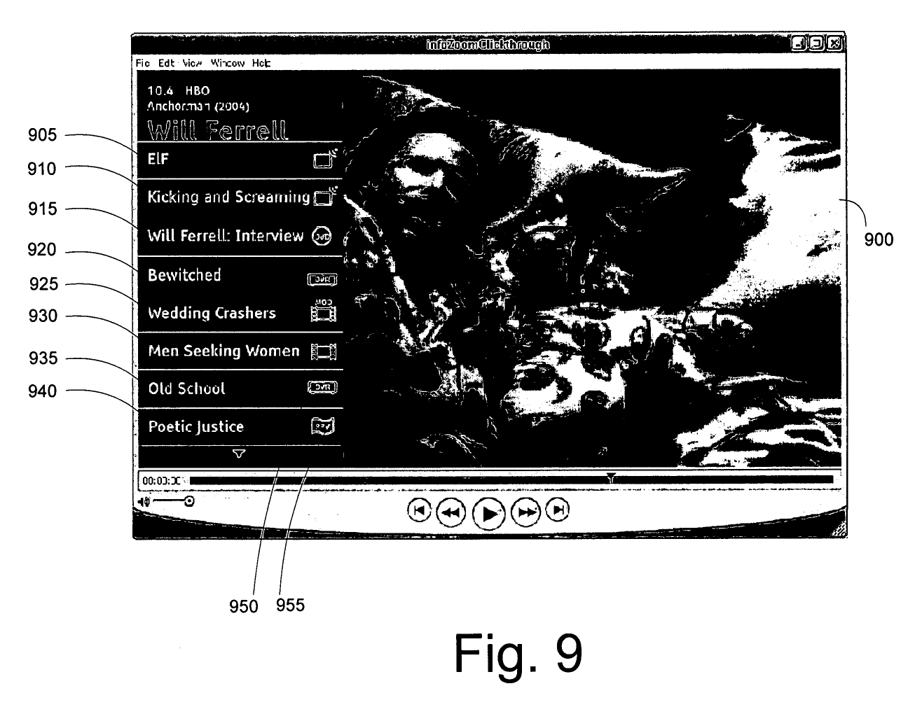

FIG. 9 is a screen diagram illustrating the resulting content displayed to a user upon selection of a given element as illustrated in FIG. 8. Selection of “Will Ferrell” in FIG. 8 results in a search for one or more items of ancillary content containing the actor Will Ferrell. As illustrated in FIG. 9, a plurality of ancillary content 905, 910, 915, 920, 925, 930, 935 and 940 is displayed to a user in conjunction with content 900 delivered to the user's client device. Each item of ancillary content 905, 910, 915, 920, 925, 930, 935 and 940 displayed to a user is displayed with an indication 950 and 955 from where the ancillary content 905, 910, 915, 920, 925, 930, 935 and 940 may be retrieved. For example, the ancillary content item “Poetic Justice” 940 is displayed with a “PPV” icon 955, indicating that the item is a pay-per-view selection, requiring the user to pay an additional fee to view the item of ancillary content. Similarly, the ancillary content item “Old School” 935 is displayed with a “DVR” icon 950, indicating that the item is available on the user's digital video recorder.

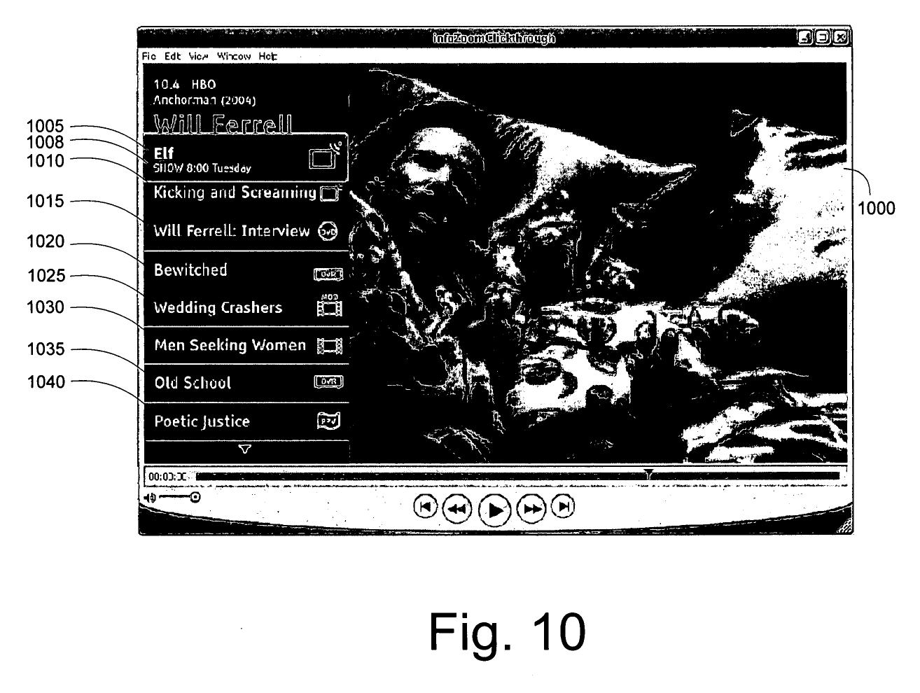

FIG. 10 is a screen diagram illustrating the additional information displayed to a user when a user traverses the list of one or more items of ancillary content displayed in FIG. 9. A user may traverse the one or more items of ancillary content 1005, 1010, 1015, 1020, 1025, 1030, 1035 and 1040 displayed to the user while viewing the content 1000 displayed on the user's client device. Using a selection device, such as a mouse or a remote control, a user may highlight or otherwise mark a given item of ancillary content 1005, 1010, 1015, 1020, 1025, 1030, 1035 and 1040 resulting in the display of additional information 1005. For example, as illustrated in FIG. 10, when an item of ancillary content 1005, 1010, 1015, 1020, 1025, 1030, 1035 and 1040 is selected, a user is presented with information 1008 identifying the network broadcasting the item of content, the time the item of content is available, as well as the day the item of content may be viewed.

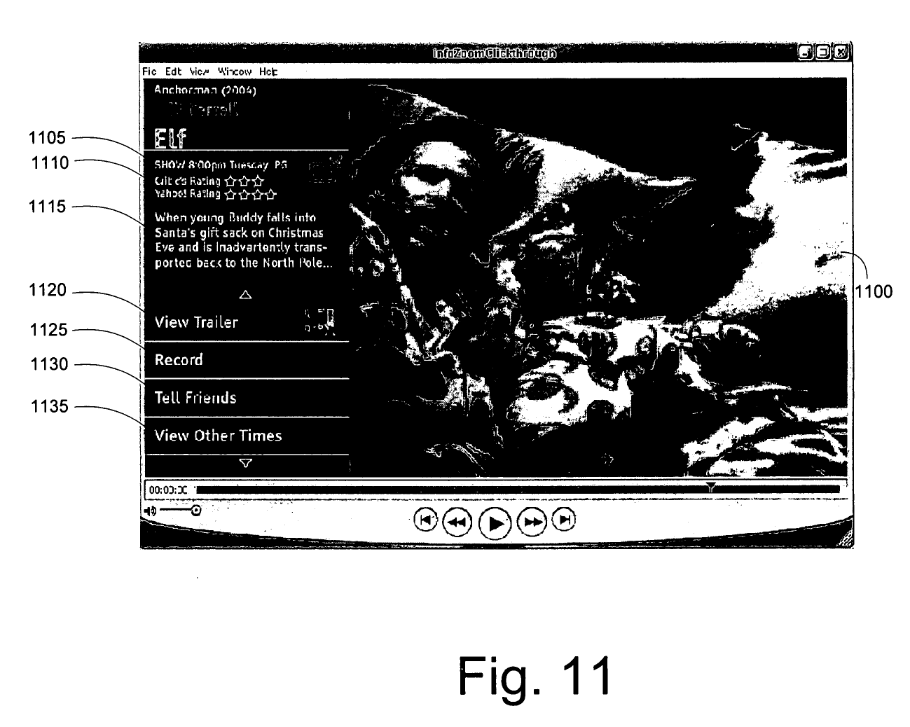

A user may also select a given item of ancillary content 1005, 1010, 1015, 1020, 1025, 1030, 1035 and 1040 in order to retrieve additional information on the respective item as well as perform one or more actions available for the item selected. FIG. 11 is a screen diagram illustrating the content displayed to a user upon selection of a given item of ancillary content. A user may be presented with additional information 1105, 1110 and 1115 for the item of ancillary content selected, such as a summary 1115 of the ancillary content or rating information 1110. According to one embodiment of the present invention, a user's selection of a given item of ancillary content is delivered to a TV application component that retrieves additional information 1105, 1110 and 1115 from a content data store for the item of ancillary content selected. The additional information 1105, 1110 and 1115 retrieved may be delivered to a user's client device and displayed in conjunction with the content 1100 displayed to the user.

Additionally, a user may be presented with a plurality of actions 1120, 1125, 1130 and 1135 that may be performed for the given item of ancillary content selected. As illustrated in the screen diagram of FIG. 11, a user may view the trailer 1120 for the movie “Elf,” record the movie 1125, notify one or more buddies in the user's social network 1130, as well as view other times when the movie is available 1135.

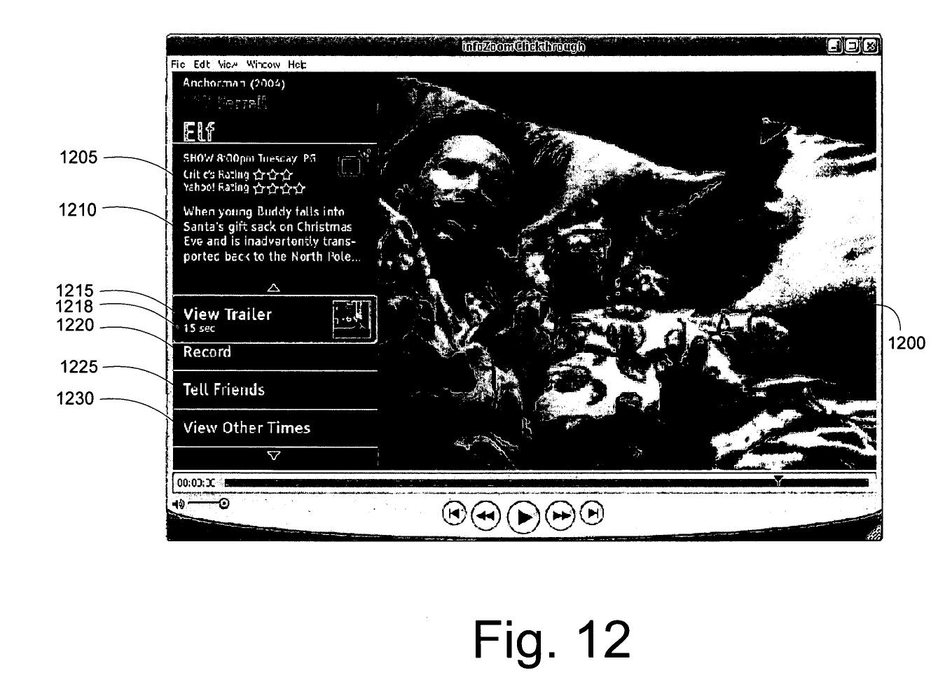

A user may traverse the one or more actions 1120, 1125, 1130 and 1135 associated with a given item of ancillary content using a selection device such as a mouse or a remote control. FIG. 12 is a screen diagram illustrating the content displayed to a user as a user traverses the one or more actions 1215, 1220, 1225 and 1230 available for a given item of ancillary content. When a given action is highlighted or otherwise marked 1215, additional information 1218 is displayed to the user, further describing the marked action. For example, when the “View Trailer” 1215 action is highlighted, the user is presented with information 1218 specifying the duration of the ancillary content, as well as an image associated with the item of ancillary content.

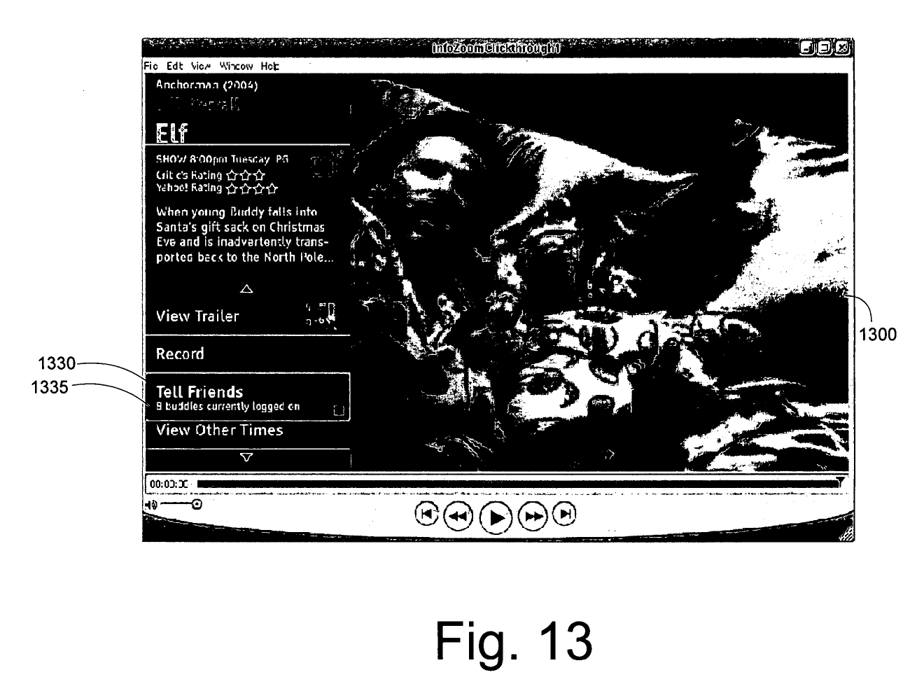

FIG. 13 is a screen diagram illustrating the information displayed to a user when the “Tell Friends” 1330 action associated with a given item of ancillary content is highlighted or otherwise marked. According to one embodiment of the invention, the “Tell Friends” 1330 action allows a user to notify one or more buddies in the user's social network of the item of ancillary content selected. A user's profile may be retrieved in order to identify one or more buddies in the given user's social network. When the “Tell Friends” 1330 action is highlighted or otherwise marked, the user is provided with information 1335 indicating the number of buddies associated with the user that are logged in to the system described herein. According to one embodiment of the invention, if a user selects the “Tell Friends” 1330 action, the user may specify the one or more buddies that are to receive a notification of the ancillary content selected by the user. The notification delivered to a user's one or more buddies may comprise an email notification, a pop-up notification, etc.

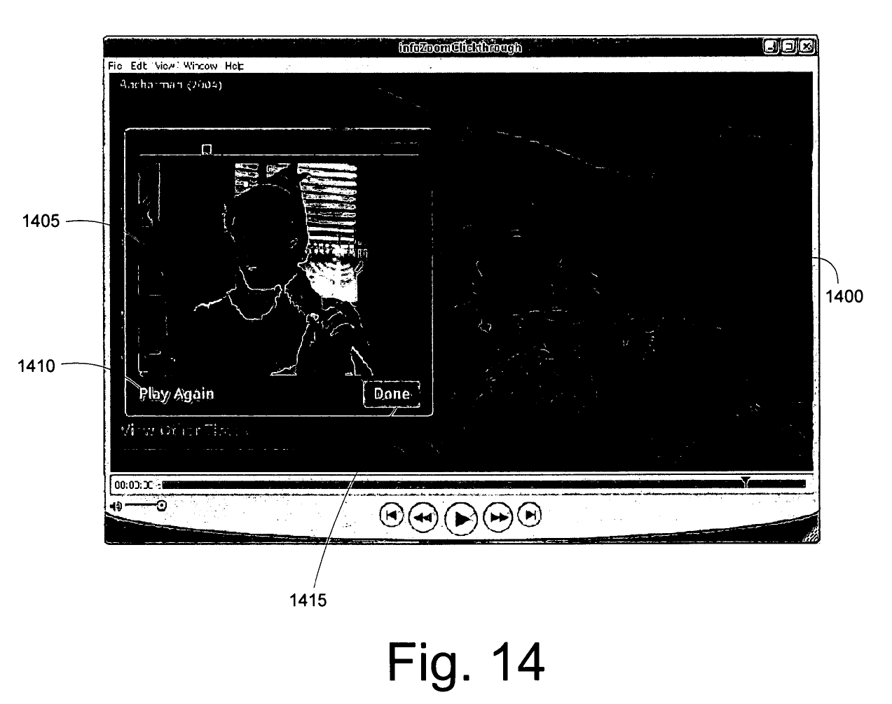

FIG. 14 is a screen diagram illustrating the content displayed to a user upon selection of the “View Trailer” action illustrated in FIG. 11, FIG. 12 and FIG. 13. The ancillary content item 1405 selected is displayed in conjunction with the content 1400 delivered to the user's client device. A user may thus view both content 1400 and ancillary content 1405 simultaneously. Furthermore, the user may be presented with one or more controls 1410 for interacting with the ancillary content 1415. As illustrated in the screen diagram of FIG. 14, a user may repeatedly play the item of ancillary content by selecting the “Play Again” 1410 option or return to the list of available actions by selecting the “Done” option 1415.

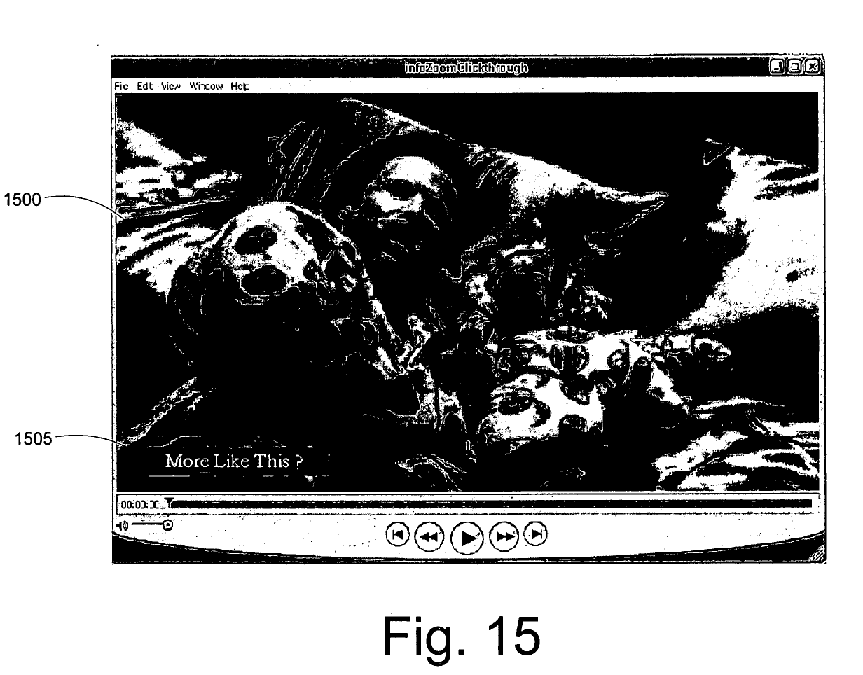

FIG. 15 is a screen diagram illustrating an alternative embodiment which includes the presentation of an option to search for one or more items of active content associated with a given user's context. Using a selection device such as a mouse or a remote control, a user may select a “More Like This” 1505 button to locate one or more items of active content associated with the user's context 1500, wherein active items of content may comprise items of content that are immediately available to the user for viewing or recording. According to one embodiment of the invention, the one or more items of content immediately available to a user may be identified based upon the one or more items of content in an electronic program guide available to the user. As illustrated in FIG. 15, the user may select the “More Like This” 1505 button while viewing one or more items of content 1505 on the user's client device.

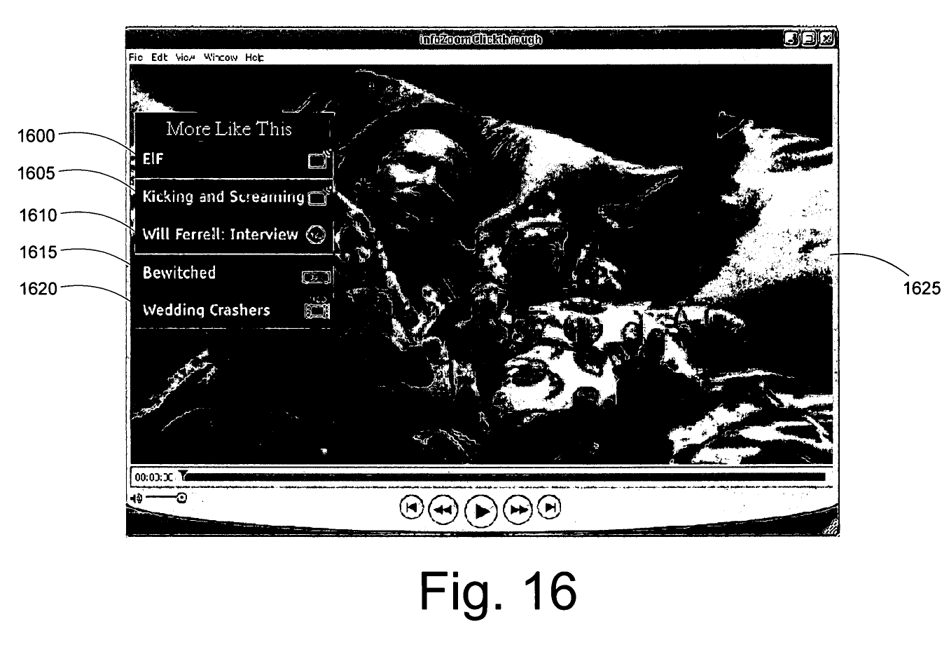

FIG. 16 is a screen diagram illustrating the plurality of active items 1600, 1605, 1610, 1615 and 1620 of associated content that may be displayed to a user upon selection of the “More Like This” button illustrated in the screen diagram of FIG. 15. As illustrated in the screen diagram of FIG. 16, one or more active items of content 1600, 1605, 1610, 1615 and 1620 associated with the user's context 1625 are displayed on the user's client device. The one or more active items of content 1600, 1605, 1610, 1615 and 1620 may be retrieved according to the methods described herein. According to one embodiment, the one or more active items of content 1600, 1605, 1610, 1615 and 1620 are retrieved based upon the one or more characteristics associated with the user's context 1625. The user may continue to view the content 1625 delivered to the user's client device while browsing the one or more active items 1600, 1605, 1610, 1615 and 1620 of content associated with the user's context. Using a selection device such as a mouse or a remote control, a user may browse the one or more active items of associated content 1600, 1605, 1610, 1615 and 1620. A user may further select one or more active items of associated content 1600, 1605, 1610, 1615 and 1620 in order to change the user's context to the item selected, record the item of content selected, retrieve rating information for the item of content selected, etc.

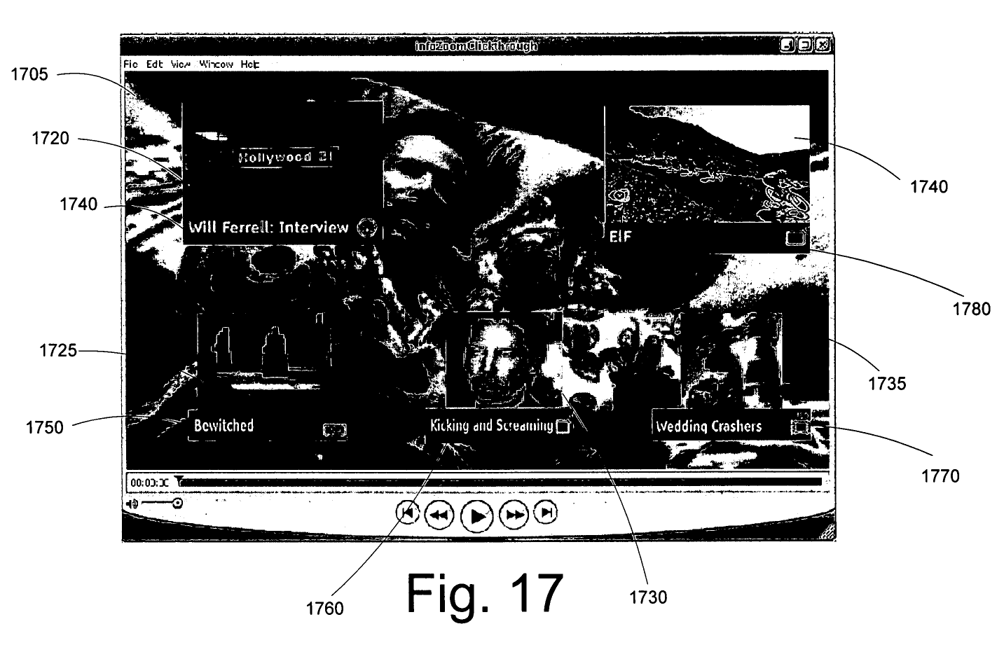

FIG. 17 is a screen diagram illustrating an alternative embodiment of the content that may be displayed to a user upon selection of the “More Like This” button illustrated in the screen diagram of FIG. 15. As illustrated in the screen diagram of FIG. 17, one or more active items of content 1720, 1725, 1730, 1735 and 1740 associated with the user's context are displayed on the user's client device. A user may view the one or more active items of content 1720, 1725, 1730, 1735 and 1740 in conjunction with the content 1705 delivered to the user's client device. Additionally, a user may select an active item of content 1720, 1725, 1730, 1735 and 1740 which may result in the user's context being updated to reflect the user's selection. A description 1740, 1750, 1760, 1770 and 1780 is provided for each active item of content 1720, 1725, 1730, 1735 and 1740 to allow a user to identify the one or more active items of content delivered to the user's client. According to the embodiment illustrated in the screen diagram of FIG. 17, a title is provided for each active item of content 1720, 1725, 1730, 1735 and 1740 displayed on the user's client device.

While the invention has been described and illustrated in connection with preferred embodiments, many variations and modifications as will be evident to those skilled in the art may be made without departing from the spirit and scope of the invention, and the invention is thus not to be limited to the precise details of methodology or construction set forth above as such variations and modification are intended to be included within the scope of the invention.

We claim:

1. A method for identifying one or more items of content associated with a user's context, the method comprising:
retrieving the context of a user;
identifying a plurality of characteristics associated with the user's context;
displaying the one or more characteristics associated with the user's context on the user's client device and allowing a user to select from the displayed characteristics;
retrieving one or more items of content based upon the user's selection; and
presenting the one or more items of content retrieved.

2. The method of claim 1 wherein retrieving the context of a user comprises retrieving information identifying the one or more items of content displayed on the user's client device.

3. The method of claim 1 wherein identifying a plurality of characteristics associated with a user's context comprises identifying the genre of the content displayed on the user's client device.

4. The method of claim 1 wherein identifying a plurality of characteristics associated with a user's context comprises identifying one or more actors in a given item of content displayed on the user's client device.

5. The method of claim 1 wherein identifying a plurality of characteristics associated with a user's context comprises identifying the geographic location depicted in an item of content displayed on the user's client device.

6. The method of claim 1 wherein identifying a plurality of characteristics associated with a user's context comprises identifying the director of an item of content displayed on the user's client device.

7. The method of claim 1 wherein displaying the one or more characteristics associated with the user's context on the user's client device comprises displaying the one or more characteristics associated with the user's context in conjunction with content displayed on the user's client device.

8. The method of claim 1 wherein retrieving one or more items of content based upon the user's selection comprises:
identifying the one or more characteristics selected by the user; and
retrieving one or more items of content with characteristics that are similar or match the characteristics selected by the user.

9. The method of claim 1 wherein presenting the one or more items of content retrieved comprises presenting the one or more items of content retrieved in conjunction with content delivered to the user's client device.

10. The method of claim 1 wherein presenting the one or more items of content retrieved comprises presenting the title of the one or more items of content retrieved.
